(19) United States
(12) Patent Application Publication
(10) Pub. No.: US 2004/0141625 A1
(43) Pub. Date: Jul. 22, 2004

(54) Sound system for a vehicle

(76) Inventor: Kurt Leipold, Feldkirchen (DE)

Correspondence Address: Samuels, Gauthier & Stevens LLP, Suite 3300, 225 Franklin Street, Boston, MA, 02110, US

(21) Appl. No.: 10/673,914

(22) Filed: Sep. 29, 2003

(30) Foreign Application Priority Data
Sep. 27, 2002 (EP) 02 021 904.4

(51) Int. Cl. H04B 1/00; H04R 1/02

(52) U.S. Cl. 381/86; 381/389

(57) ABSTRACT

Sound system for a vehicle that has at least one door, with a low-frequency loudspeaker, the resonant volume of which, at least when the door is closed, is formed, on the one hand, by a first cavity situated in the door and, on the other hand, by a second cavity coupled to the first cavity by a coupling device and situated outside the door.

### BACKGROUND OF THE INVENTION

The invention relates to a vehicle sound system having a low-frequency loudspeaker.

One problem when installing low-frequency loudspeakers in motor vehicles is that low-frequency loudspeakers require a large resonant volume. However, there is generally limited space for such a large resonant volume. In addition, the candidate locations with large resonant volumes are often not suitable for the installation of low-frequency loudspeakers, since the low-frequency loudspeakers require a large, substantially flat surface for installation. In a motor vehicle, there are few locations that offer both a large flat surface for the mounting of the loudspeaker, and a large resonant volume.

German Patent DE 4413626, for example, has disclosed mounting a loudspeaker in various ways under the vehicle headliner. Although the available area is large, the installation depth and the resonant volume between the headliner and the roof is rather small and often insufficient. Therefore, at best, only very shallow low-frequency loudspeakers to be installed. Moreover, the resonant volume is not sufficient in most cases.

German Patent DE 4439461 discloses accommodating loudspeakers in side doors of passenger cars. Although the doors of motor vehicles provide flat surfaces that are suitable for mounting loudspeakers, the volume enclosed by the doors is severely restricted by the window and window-control mechanism, when the window is retracted. As a result, this volume is generally insufficient for a low-frequency loudspeaker.

European Application EP 0904985 discloses an arrangement in which the low-frequency loudspeaker is fitted under a vehicle seat, and the resonant volume of the low-frequency loudspeaker is formed at least partially by the sill volume enclosed by a support frame. In this arrangement, the loudspeaker is situated in a relatively small loudspeaker box under the vehicle seat. The resonant volume of the low-frequency loudspeaker is formed by the volume in the box and the acoustically coupled volume in a support frame of the vehicle. Acoustic coupling is accomplished by through opening in the support frame and in the box. The volume in the support frame is connected to the surrounding area by diffusion openings, so the external volume of the surrounding area is added to the volume in the box and to the volume in the support frame. Since the external volume is unlimited, the low-frequency loudspeaker can operate with an unlimited resonant volume especially in the case of low-frequency sounds.

However, with this arrangement, the space for the installation of a low-frequency loudspeaker is extremely small since the loudspeaker is covered by the seat in all the positions of the seat. In addition, space is often required under the seat to ensure that rear seat passengers have sufficient foot room. Therefore, loudspeakers with a large diaphragm surface are difficult to arrange under the vehicle seat.

Therefore, there is a need for improved mounting of a loud speaker within a motor vehicle.

### SUMMARY OF THE INVENTION

The invention eliminates the problems known from the prior art by virtue of the fact that the resonant volume of the low-frequency loudspeaker is formed by a first cavity situated in the door, and by a cavity coupled to the first cavity by a coupling device and situated outside the door. A largely closed volume surrounded by a rigid wall is preferably used as a cavity. Thus the first cavity can be a volume enclosed by the door frame, the exterior panel and/or the interior lining of the door, for example. The nature of the coupling device between the first and the second cavity is such that it allows adequate pressure compensation and exchange of air between the two cavities. Any desired volume of virtually any desired shape, preferably situated in the vicinity of the door, can be used as a second cavity, although the volume should, of course, be sufficiently large.

The first and second cavity can each have an opening, which correspond to one another in such a way that they come to rest against one another when the door is closed. The opening of the second cavity can be arranged at any desired point in the door as long as there is another part of the vehicle with a point suitable for the introduction of the second opening opposite the opening in the first cavity. These can be all the narrow sides of the door, for example.

To achieve sealed coupling between the two openings, at least one of the two openings can be provided with a sealing lip, which is pressed against the rim of the other opening or—where present—against another sealing lip when the door is closed.

To prevent penetration by relatively large particles when the door is open, at least one of the two openings can be provided over the entire cross-sectional area with an acoustically neutral cover that is permeable to air. Preferably, the opening belonging to the cavity containing the low-frequency loudspeaker is covered, to prevent for example penetration by small stones, relatively large dirt particles and the like, for example.

The two cavities may be coupled to one another by a telescopic tube connection. This may be formed by two nested tubes, which can be displaced one inside the other and remain nested one inside the other even when the door is open. When the door is closed, the tubes are pushed further or completely into one another. Depending on their mounting, the tubes can be straight or bent in accordance with the motion of the door. The tubes can also be of different lengths, it being possible for the shorter tube to act as a guide for the longer tube and the longer tube to be pushed into one of the cavities.

At least one of the tubes can be of flexible design and/or can be connected in an articulated manner to one of the two cavities. A flexible sleeve is preferably provided as the articulated joint.

A bellows may be provided as a coupling device. The bellows may connect the two openings in the cavities, thus coupling the two cavities. A bellows adapts easily to the different positions of the door. The bellows may include a round cross section, but may have any other cross section and be made of a relatively rigid material, such as for example plastic.

A flexible hose that connects the two openings in the cavities may also be provided as a coupling element. The hose is preferably thick-walled in order to form a rigid enclosing wall with regard to sound transmission. For coupling, it can be employed in a wound, spiral or similar arrangement.

The low-frequency loudspeaker may be surrounded by a box defining the first or second cavity. In this way, it is possible to define a clearly delimited volume directly adjoining the loudspeaker. Further, it is thereby possible to protect the loudspeaker against soiling and/or penetrating moisture from the rear as well if installing it in the side door, for example.

It is furthermore possible, in the case of at least one of the cavities, to provide diffusion openings that connect at least one of the two cavities to the exterior of the resonant volume, for example the volume surrounding the vehicle. Since the exterior volume is relatively unlimited, the loudspeaker can operate with a large resonant volume, which is desirable for good reproduction of low-frequency sound.

The second cavity is preferably formed at least partially by hollow parts of the support frame of the motor vehicle. Suitable parts of this kind include for example, the A-pillar, the B-pillar, the C-pillar, roof-support elements and/or the sill of the vehicle. In addition or as an alternative, the second cavity can also be formed by a volume surrounded by bodywork parts of the vehicle, for example a volume formed by the side walls of the footwell or parts of the vehicle roof in conjunction with the vehicle headliner.

The loudspeaker is preferably installed either in the door or in the bodywork, for example the side walls of the footwell. The other volume in each case (i.e., the bodywork parts or the door) then form the additional resonant volume in the form of the second cavity.

The first, second or both cavities may be coupled to additional cavities located outside the door by further coupling devices. In this way it is possible, for example, to couple a plurality of relatively small volumes to the first cavity via the support frame, thus providing a rather large effective resonant volume.

These and other objects, features and advantages of the present invention will become more apparent in light of the following detailed description of preferred embodiments thereof, as illustrated in the accompanying drawings.

### BRIEF DESCRIPTION OF THE DRAWINGS

FIG. 1 shows schematically a vehicle door and the frame parts surrounding it, with various options for the implementation of a sound system;

FIG. 2 shows another option for the implementation of a sound system;

FIG. 3 shows a horizontal section through the vehicle door and the frame part to illustrate the transition from the door volume to the support frame volume, with the door open;

FIG. 4 shows the arrangement in accordance with FIG. 3 with the door closed;

FIG. 5 shows yet another horizontal section through the vehicle door and the frame part to illustrate the transition from the door volume to the support frame volume, with the door open;

FIG. 6 shows the arrangement in accordance with FIG. 5 with the door closed;

FIG. 7 shows still yet another horizontal section through the vehicle door and the frame part to illustrate the transition from the door volume to the support frame volume, with the door open with a lip-seal transition;

FIG. 8 shows the arrangement in accordance with FIG. 7 with the door closed;

FIG. 9 shows a vertical section through the transition between the vehicle door, and the supporting frame, accomplished by a wound flexible hose;

FIGS. 10A and 10B illustrate the principle of the flexible hose applied in the arrangement in accordance with FIG. 9; and

FIGS. 11A and 11B illustrate an alternative embodiment to the embodiment in accordance with FIG. 9 with a spiral hose.

### DETAILED DESCRIPTION OF THE INVENTION

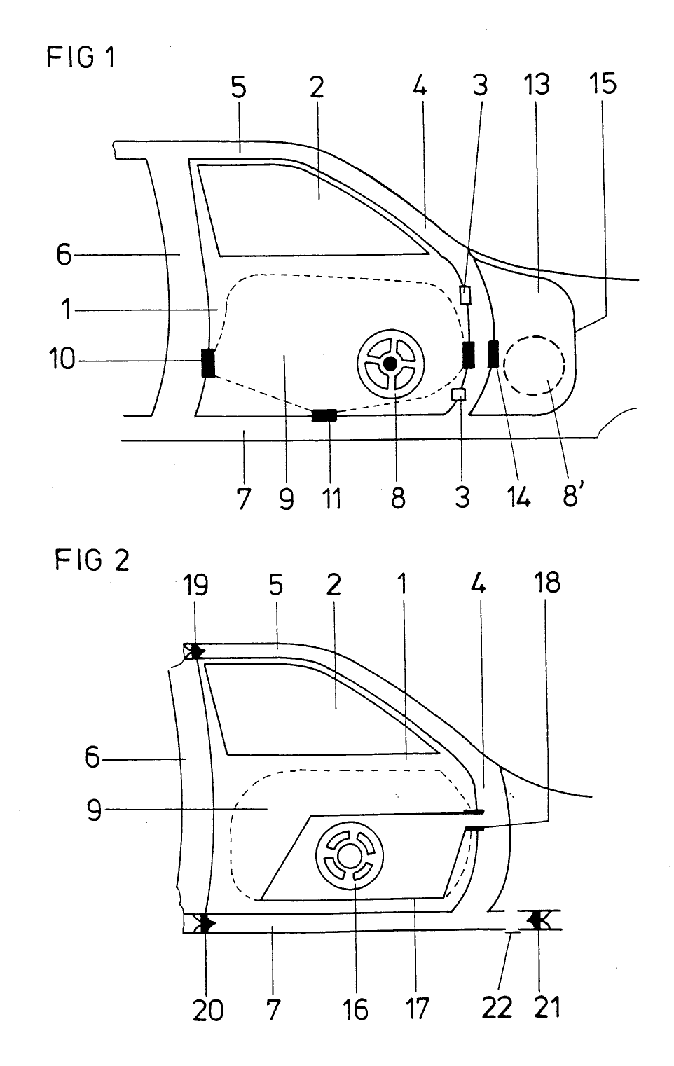

FIG. 1 partially illustrates a motor vehicle door 1 connected in an articulated manner by hinges 3 to an A-pillar 4 of the vehicle. The door include a window 2. As well as being framed by the A-pillar, the door 1 is framed on the remaining narrow edges by a roof support 5, a B-pillar 6 and a sill 7. When closed, the door 1 seals against: (i) the roof support 5 on its upper side, (ii) the B-pillar 6 on its side opposite the hinges 3,(iii) and with the sill 7 on its underside. Installed in the door 1, underneath the window 2, is a loudspeaker 8 that uses the door volume 9 enclosed by the door 1 underneath the window 2 as a resonant volume.

The resonant volume may be enlarged by additional volumes/cavities available in the vehicle, that are pneumatically coupled to the door volume 9. The door volume 9 is coupled to the additional volumes by coupling devices 10, 11 and 12.

Thus, the (effective) door volume 9 is coupled to the volume of the B-pillar 6 by coupling device 10, to the volume present in the sill 7 by coupling device 11, and to the volume that occurs in the A-pillar 4 by coupling device 12. Examples of coupling devices of this kind will be described below.

The coupling devices 10, 11 and 12 facilitate a largely unhindered exchange of air between the individual volumes. In this arrangement, the individual additional volumes can be self-contained or, alternatively, connected to one another, as shown in FIG. 1. The effective door volume 9 thus forms a first volume, which is connected to a second volume defined by the A-pillar 4, the B-pillar 6, the roof support 5 and the sill 7. However, the A-pillar 4, the B-pillar 6, the roof support 5 and the sill 7 may form independent individual volumes, which may be independently coupled to the effective door volume 9. Thus a first volume may be coupled to a plurality of additional individual volumes.

An additional volume may include a second volume 13 pneumatically coupled to the door volume 9 via a coupling device 14. The second volume 13 may be a cavity enclosed by the A-pillar 4 and by bodywork parts 15, of the type that occurs under the side walls of the driver's and front seat passenger's footwell, for example.

As an alternative, the loudspeaker 8 may be mounted in a corresponding position 8′ in the second volume 13, on the outer parts 15. In yet another embodiment, the system may include a loudspeaker 8 and a second loudspeaker located at location 8′.

FIG. 2 is a pictorial illustration of another embodiment speaker system embodiment. In this embodiment, loudspeaker 16 is installed in a housing 17 that hermetically seals the loudspeaker on the rear side. An advantage of the housing 17 is that the resonant volume for the loudspeaker 16 is precisely defined. That is, the volume without a housing 17 can change as the window is raised and lowered, for example. Another advantage with the housing 17 is that, apart from intended sound openings, it can be made airtight.

The volume in the housing 17 may not be sufficient for good bass reproduction, and is therefore coupled by a coupling device 18 to the cavity enclosed by the A-pillar and hence to its volume. The volume in the A-pillar 4 merges into the volume of the roof support 5 and the volume of the sill 7. Sealing plugs 19 and 20 are inserted into the roof support 5 and the sill 7 at the level of the B-pillar 6, and sealing plug 21 is positioned at the transition between the sill 7 and the A-pillar 4 to ensure sealing relative to other parts of the support frame.

To enlarge the resonant volume of the loudspeaker 16 even further, the exterior of the vehicle is coupled in by a diffusion opening 22. Since the external volume is unlimited, the loudspeaker can operate with an unlimited resonant volume, significantly improving bass reproduction. The loudspeaker 16 radiates sound exclusively towards the front (i.e., into the vehicle interior) since the loudspeaker 16 is acoustically insulated from the support frame, at least with respect to high frequencies. As a result, acoustic coupling of the support frame to the loudspeaker 16 (i.e., excitation of the support frame by the loudspeaker) is prevented.

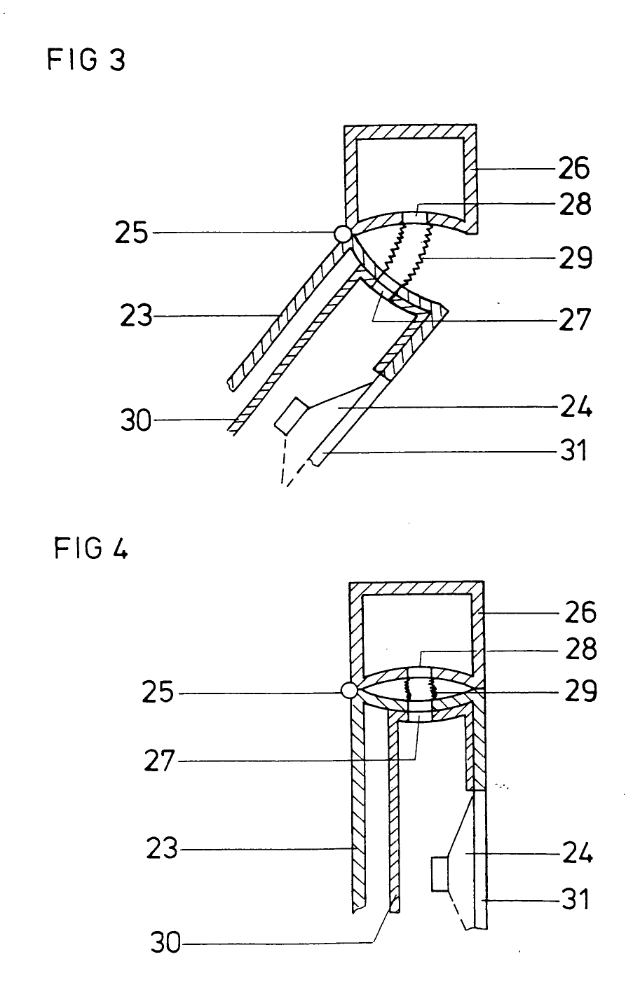

The coupling device 18 for coupling the box 17 to the support frame in accordance with FIG. 2 and, for example, the coupling device 12 from FIG. 1 can be embodied like the exemplary embodiments of coupling devices shown in FIGS. 3 to 12.

Referring to FIG. 3, a door 23 that includes a cavity within which loudspeaker 24 is mounted, is attached to a support-frame part 26 (e.g. an A-pillar) in an articulated manner by a hinge 25. The support-frame part 26 and the door 23 curve inwards on their mutually opposite sides, with the result that in the closed state (see FIG. 4), they enclose a cavity of oval cross section, which does not act as a resonant volume. At least one opening 27/28 is formed in each of the two mutually facing surfaces of the door 23 and the support-frame part 26.

One end of a beam 29 is secured in a sealing manner in each of the two openings 27/28, providing a sealed joint between the cavity enclosed by the door 23 and the cavity enclosed by the support-frame part 26. FIG. 3 also shows, in cross section parts of a box 30 enclosing the loudspeaker 24. The use of the box 30 is optional and it has been omitted in the subsequent embodiments for the sake of clarity, but it can be employed in these in the same manner as shown in FIG. 3.

As shown in FIG. 3, the loudspeaker 24 radiates into the vehicle interior (not shown) through a front opening 31 situated in the door, while a first resonant volume is formed on its rear side by the box 30. A second resonant volume defined by the support-frame part 26 is coupled to the first resonant volume by bellows 29.

FIG. 4 illustrates the arrangement in accordance with FIG. 3 with the door 23 closed. The bellows 29 is enclosed in the cavity formed by the curved mutually facing sides of the door 23 and of the support-frame part 26 when compressed. Referring to FIGS. 3 and 4, the difference between the change in volume between the extended bellows 29 and the compressed bellows 29 in comparison with the total resonant volume (i.e., the volume of the box 30 and the volume defined by the support part 26) is so small in total that it is negligible and hence there is no change in the acoustic properties of the overall system due to a change in resonant volume.

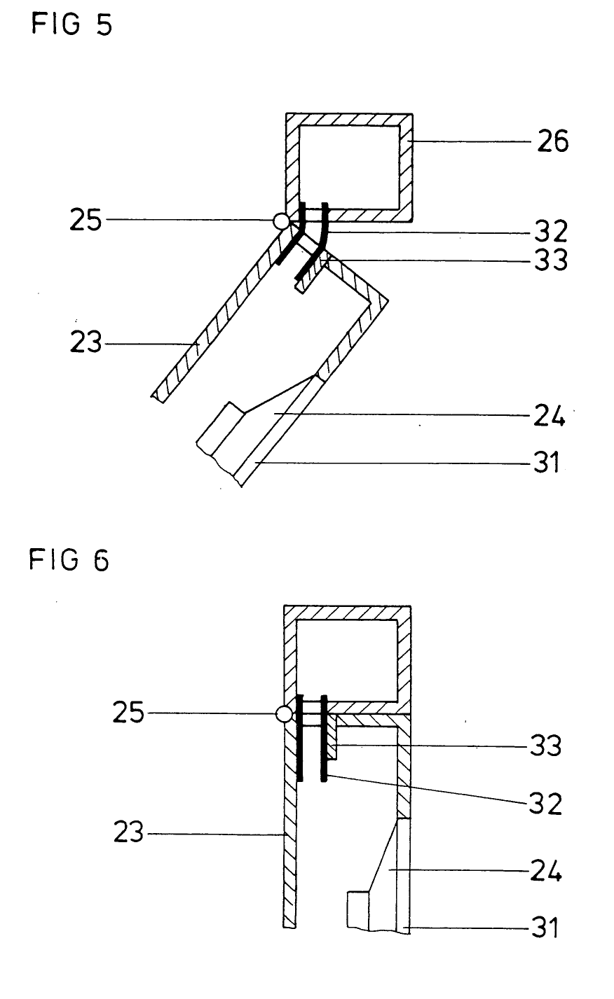

FIG. 5 illustrates a modification of the embodiment illustrated in FIG. 3. The support-frame part 26 and the door 23 are of flat design on the mutually opposite sides, in contrast to FIG. 3, but can have any desired shape. The openings in the support-frame part 26 and in the door 23 for coupling the two volumes are arranged in the vicinity of the hinge 25 in order to reduce the difference in spacing between the support-frame part 26 and the door 23 when the door 23 is open and when it is closed. The coupling device comprises two telescopically nested tubes 32 and 33, of which the tube 32 with the somewhat smaller cross section is connected firmly at one end to the openings situated in the support-frame part 26 and extends away from the support-frame part 26 in the direction of the door 23. The tube 33 of larger diameter also extends in the same direction, the tube 32 being inserted into tube 33 and being displaceable in the latter.

As the door is open and closed, the tube 32 is displaced in a corresponding manner in the tube 33. Since there is no resulting linear motion, owing to the rotatably hinged mounting of the hinge 25, but a motion along a circular segment, it is necessary to support at least one of the two tubes in a self-articulated manner or, to make at least one of the two tubes flexible. In one embodiment the tube 32 is flexible. However, both tubes may be flexible, or alternatively only the tube 33 is flexible. As already mentioned, both tubes may also be rigid, in which case both may be supported in the respective opening by for example, a rubber sleeve.

Part of the tube 33 may be formed by the side wall of the door 23, with the result that both the tubes 32, 33 are positioned as close as possible to the hinge 25. A rubber hose is provided as a flexible tube 32, which provides good flexibility transversely to its longitudinal axis, with sufficient rigidity in the direction of its longitudinal axis to be pushed into tube 33.

FIG. 6 shows the arrangement in accordance with FIG. 5 when the door is closed. In this case, the rubber hose used as tube 32 is pushed into tube 33 largely in a straight line. The use of a rubber hose an advantage that the two tubes 32 and 33 are to a large extent sealed off relative to one another owing to the sealing properties of rubber, with the result that there is no need for additional sealing measures (e.g., ring seals) in this configuration. To provide better sliding properties and enhance the sealing effect, the rubber hose provided as tube 32 and/or tube 33 can be treated with a lubricant (e.g., lubricating grease). As can be seen from FIGS. 5 and 6, a sealed joint between the volume enclosed by the support-frame part 26 and the volume enclosed by the door 23 is possible in every state of the door.

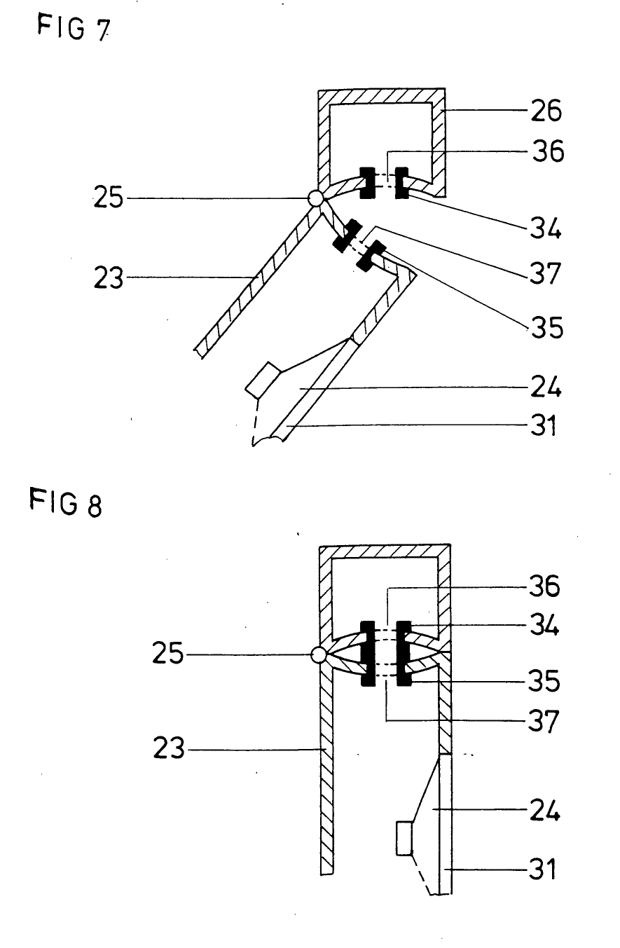

Referring to FIG. 7, the coupling between the cavity enclosed by the support-frame part 26 and the cavity enclosed by the door 23 is effective when the door is closed. When the door is open, the two cavities are connected to the environment. In the closed state, two rubber sleeves 34 and 35 secured in openings situated in the mutually facing ends of the support-frame part 26 and of the door 23, are pressed against one another. FIG. 8 shows the situation when the door 23 is closed. To prevent penetration by relatively large dirt particles, dust or the like, both openings in the present case are covered by covers 36 and 37, which are permeable to air and, for example, are formed by a fine-mesh grill or a gauze.

The embodiment shown in FIGS. 7 and 8 can also be used in a slightly modified form for the coupling pieces 10 and 11 in FIG. 1. In this case, two sealing lips corresponding to the sealing lips 36 and 37 would then not be pressed against one another by a tilting movement but would initially be moved relative to the door 1 by means of a mutually parallel displacement of the sill 7 or of the B-pillar 6, for example. In the closed state, the lips would then be one above the other again and would press against one another through their own elasticity, for example.

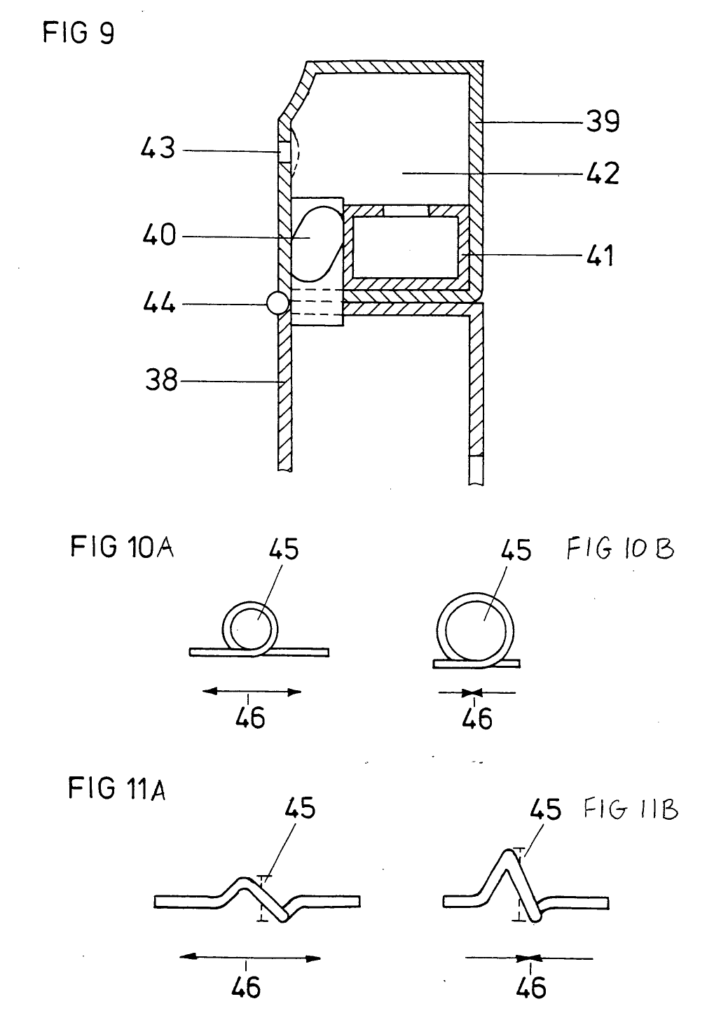

FIG. 9 shows an embodiment wherein a cavity enclosed by a door 38 being coupled to a cavity is enclosed by bodywork parts 39. Coupling is accomplished by a wound hose 40. The connection between the two cavities is arranged in the vicinity of a hinge 40 that secures the door 38 in an articulated manner on the bodywork parts 39. The hose 40 leads past a support-frame part 41 which, for its part, encloses a cavity. This cavity is coupled to the cavity enclosed by the bodywork parts 39 via an opening 42.

Moreover, the cavity enclosed by the bodywork parts 39 is connected to the surrounding area by a diffusion opening 43. However, bass-reflex openings et cetera may be employed instead of a diffusion opening. In one embodiment, the wound hose has only one turn, the cross section of which decreases during a longitudinal motion, as illustrated in FIG. 10A, but increases in cross section 45 during a longitudinal compression as shown in FIG. 10B. If the door is closed, as illustrated in FIG. 9, the hose 40 lies largely in a cavity formed between the bodywork parts 39 and the support-frame part 41. When the door is opened, the hose is pulled out of this cavity, reducing the cross section of the turn.

If the cavity provided to accommodate the hose 40 is sufficiently large, it is also possible for a coil-shaped spiral to be provided instead of a loop-shaped turn (as illustrated in FIGS. 10A-10B), this spiral responding to extension in the longitudinal direction in a manner comparable to a spiral spring. The behaviour of a hose 40 wound in this way is illustrated in FIGS. 11a and 11B, in the case of extension and in the case of compression, respectively.

A large number of other embodiments are conceivable in addition to the embodiment already shown, these being obtained, in particular, by modifications and combinations of the embodiments already shown.

Although the present invention has been shown and described with respect to several preferred embodiments thereof, various changes, omissions and additions to the form and detail thereof, may be made therein, without departing from the spirit and scope of the invention.

What is claimed is:

1. A sound system for a vehicle comprising at least one door, said sound system comprising:
a low-frequency loudspeaker having a resonant volume formed by a first cavity situated inside of the door and by a second cavity situated outside of the door; and
means for pneumatically coupling said first and second cavities to form said resonant volume.

2. The sound system according to claim 1, wherein said means for coupling comprises a first opening in the first cavity and a second opening in the second cavity, said first and second openings being arranged in close proximity to each other when said door is closed.

3. The sound system according to claim 2, wherein at least one of the two openings is provided with a sealing lip, which is compressed when the door is closed and seals off the coupling of the two cavities from the outside.

4. The sound system according to claim 2, wherein at least one of the two openings is provided over the cross-sectional area with an acoustically neutral cover that is permeable to air.

5. The sound system according to claim 1, wherein the two cavities are coupled to one another by a telescopic tube connection.

6. The sound system according to claim 5, wherein the telescopic tube connection has two tubes that can be displaced one inside the other and engage in openings of the cavities.

7. The sound system according to claim 6, wherein at least one of the tubes is connected in an articulated manner to one of the two cavities.

8. The sound system according to claim 7, wherein a partially flexible tube is provided for the articulated connection.

9. The sound system according to claim 1, wherein the two cavities are coupled to one another by a bellows, which connects two openings in the cavities.

10. The sound system according to claim 1, wherein the two cavities are coupled to one another by a flexible hose that connects two openings in the cavities.

11. The sound system according to claim 10, wherein the low-frequency loudspeaker is surrounded by a box defining the first or second cavity.

12. The sound system according claim 1, wherein at least one of the cavities is open to the outside of the resonant volume via diffusion openings.

13. The sound system according to claim 1, wherein the second cavity includes a volume defined at least by hollow parts of the support frame of the vehicle.

14. The sound system according to claim 13, wherein the support frame includes an A-pillar of the vehicle.

15. The sound system according to claim 13, wherein the support frame includes a B-pillar of the vehicle.

16. The sound system according to claim 13, wherein the support frame includes a sill of the vehicle.

17. The sound system according to claim 1, wherein the second cavity includes a volume surrounded by bodywork parts of the vehicle.

18. The sound system according to claim 17, wherein the low-frequency loudspeaker is installed in the bodywork parts.

19. The sound system according to claim 1, in which the low-frequency loudspeaker is arranged in the door.

20. The sound system according to claim 1, wherein the first cavity is pneumatically coupled to a third cavity situated outside the door by further coupling devices.
